(19) United States
(12) Patent Application Publication
(10) Pub. No.: US 2006/0049912 A1
(43) Pub. Date: Mar. 9, 2006

(54) Trimmable resistors having improved noise performance

(76) Inventors: Oleg Grudin, Montreal (CA); Leslie M. Landsberger, Westmount (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/229,565

(22) Filed: Sep. 20, 2005

Related U.S. Application Data
(63) Continuation of application No. PCT/CA04/00399, filed on Mar. 19, 2004.

(51) Int. Cl. H01C 10/00

(52) U.S. Cl. 338/195

(57) ABSTRACT

There is described a method for designing a circuit having a plurality of thermally mutable electrical components having different power dissipation and noise tolerance requirements, the method comprising: identifying a desired value for said noise tolerance and said power dissipation for each of said plurality of components; selecting a parameter value for each of said plurality of components; and selecting a dimension for each of said plurality of components as a function of said power dissipation and noise tolerance requirements to yield a trimmable range including said parameter value.

### CROSS-REFERENCE TO RELATED APPLICATIONS

This application is a continuation of international application number PCT/CA2004/000399, which claims priority under 35USC§119(e) of U.S. provisional patent application No. 60/455886 and is related to PCT patent application entitled “Bi-Directional Thermal Trimming of Electrical Resistance” having international publication number WO2004/097859 and PCT patent application entitled “Trimming Temperature Coefficients of Electronic Components and Circuits” having international publication number WO2004/097860, both filed on Mar. 19, 2004, which are hereby incorporated by reference.

### FIELD OF THE INVENTION

The invention relates to the noise performance and long-term stability of trimmable polysilicon resistors. More specifically, it relates to improving the noise performance by increasing an area of polysilicon resistor on a thermally isolated microstructure.

### BACKGROUND OF THE INVENTION

When analog electronic circuits and systems are calibrated to very high precision, many forms of fine variability become significant. Subtle parasitic effects can degrade the performance of a finely tuned circuit or system. One very important type of parasitic effect is electrical noise phenomena. Another important type of parasitic effect is long-term instability.

Electrical noise is a significant issue in the design and performance of high-precision circuits. Signal-to-noise ratio is of fundamental importance in any circuit involving amplification, including Wheatstone bridges and many sensors and sensor-based systems.

Electrical noise in resistors made of polycrystalline materials has been shown to be roughly dependent on the number of grains in the body of the resistor (M. J. Deen, S. Rumyantsev, J. Orchard-Webb, “Low-Frequency Noise in Heavily-Doped Polysilicon Thin Film Resistors”, Journal of Vacuum Science and Technology B, 16(4) July/August 1998 p.1881-1884; R. Brederlow, W. Weber, C. Dahl, D. Schmidt-Landsiedel, R Thewes, “Low-Frequency Noise of Integrated Poly-Silicon Resistors”, IEEE Trans. Electron Devices, 48(6), June 2001, p.1180-1187; R. Thewes et al, “Explanation and Quantitative Model for the Matching Behavior of Poly-Silicon Resistors”, Proceedings of the 1998 International Electron Devices Meeting, pp. 28.7.1-28.7.4, and other publications). It is known that the noise is inversely proportional to the volume of the resistor.

Moreover, it is known (N. N. Tkachenko, “1/f Noise Transformation that Accompanies the Trimming of Polycrystalline Silicon Layers”, Solid State Phenomena, Vols. 51-52 (1996), pp.391-396), that the process of pulsed trimming of polysilicon resistors can affect their electrical noise (either reducing or increasing the noise, depending on some conditions). In general, it is known that thermal trimming of polysilicon involves changes at the grain boundaries. Feldbaumer and Babcock (1995) found that trimming polysilicon reduced the average grain size of the polysilicon, which can be seen as potentially favorable for systematic reduction of noise by thermal trimming.

Long-term drift of electronic component values over time is a substantial problem in the electronics industry. It is known that mechanical stress (e.g. introduced during packaging, or other operations), may adversely affect the long-term stability of electronic components (such as resistors, diodes, FET's, and larger circuits). It is also known that trimming is associated with high temperatures (e.g. 700° C.), which may locally alter the stresses in surface layers adherent to a rigid substrate, such as in a typical silicon integrated circuit. Kato et al (K. Kato, T. Ono, Y. Amemiya, A Monolithic 14 Bit D/A Converter Fabricated with a New Trimming Technique (DOT) IEEE J. Solid-State Circuits vol. SC-19 (1984), 5, pp.802-807) found that trimming of polysilicon resistors embedded in surface films on a substrate led to increase in instability, which could be reduced by using the proposed ETR technique to anneal the resistor. In general, lower mechanical stress should lead to better long-term stability of electronic components and circuits.

Thus, if it is desired to make a resistor for a high-performance analog system, which is simultaneously high-precision trimmable, and possessing low noise characteristics, one must use a physical resistor element taking considerable area on the chip. If such a large-area resistor were simply placed on the surface of a silicon chip, even if isolated by typical insulating films, the thermal isolation from the substrate would still not be very high. It would require considerable applied power to raise the temperature high enough to accomplish trimming, raising a variety of problems impacting the practicality of the technique. Indeed, it should be noted in the prior art of trimmable polysilicon resistors (e.g. Dallas Semiconductor patent application #6306718), that the tested trimmable resistors are very small, likely in order to limit the power needed to accomplish trimming. This entrains great difficulty in creating practically manufacturable low-noise trimmable resistors.

Therefore, there is a need for trimmable resistors to have low-noise properties.

### SUMMARY OF THE INVENTION

Accordingly, an object of the present invention is to provide high-precision adjustability simultaneously with low-noise performance, suitable for use in high-performance analog systems including sensors and sensor-based systems.

According to a first broad aspect of the present invention, there is provided a circuit having favorable noise performance, the circuit comprising: a thermally isolated micro-platform on a substrate; and a thermally mutable component on the thermally isolated micro-platform taking up a majority of an area of said micro-platform.

According to a second broad aspect of the present invention, there is provided a method for providing a circuit including at least one trimmable electronic component having low noise performance, the method comprising: providing a thermally isolated micro-platform on a substrate; and placing the trimmable electronic component on the thermally isolated micro-platform such that the component covers a majority of an area of the micro-platform.

Preferably, the total area of a single thermally-trimmable component is greater than 10000 μm², disposed on a single micro-platform or on a plurality of micro-platforms. Also, the component is disposed on one or more polysilicon layers in a given micro-platform.

According to a third broad aspect of the present invention, there is provided a circuit having favorable noise performance, the circuit comprising: a thermally isolated micro-platform on a substrate; and a thermally mutable component embedded in said thermally-isolated micro-platform and composed of a plurality of superimposed layers, whereby a large effective area of said component reduces noise.

According to a fourth broad aspect of the present invention, there is provided a method for providing a circuit having low noise performance, the method comprising: providing a thermally isolated micro-platform on a substrate; and embedding a thermally mutable electrical component composed of a plurality of superimposed layers in said thermally-isolated micro-platform, whereby a large effective area of said component reduces noise.

According to a fifth broad aspect of the present invention, there is provided a method for designing a circuit having a plurality of thermally mutable electrical components having different power dissipation and noise tolerance requirements, the method comprising: identifying a desired value for said noise tolerance and said power dissipation for each of said plurality of components; selecting a parameter value for each of said plurality of components; and selecting a dimension for each of said plurality of components as a function of said power dissipation and noise tolerance requirements to yield a trimmable range including said parameter value.

According to a sixth broad aspect of the present invention, there is provided a circuit comprising a plurality of thermally mutable electrical components having different power dissipation and noise tolerance requirements, characterized in that a dimension for each of said plurality of components is set as a function of said power dissipation and noise tolerance requirements to yield a trimmable range including a desired parameter value.

In the case that the components are resistors and the trimmable components are used in a low voltage logic circuit, power dissipation is typically very low and power dissipation considerations will have minimal or negligible impact on the specifications of the dimensions of the component. In the case of analog circuitry operating at higher current and/or voltage levels in which power dissipation must be accounted for, it will be appreciated that this factor will partly determine component dimensions. In the case that a trimmable resistor is provided on a micro-platform, one must also take into consideration that the micro-platform is a highly insulated environment and even smaller power dissipation can have appreciable effects. It will be appreciated that in the present invention, trimmable resistors or other component are preferably provided on micro-platforms for ease of trimming, however, it is contemplated that such components may also be provided directly in the substrate of an integrated circuit or any other suitable packaging.

In this patent application, the term “thermally-mutable material” is intended to mean a material that behaves like a polycrystalline semiconductor material having electrical and/or other material properties that can be reversibly changed within a certain range by restructuring of the “grains” making up the material and/or grain boundaries, and/or spatial distribution of dopants within the grains, and/or grain boundaries. Once a change to the property is effected, it remains essentially stable for the purposes of subsequent operation. Such restructuring can be achieved by thermal cycling and/or by physical stimulation such as application of pressure, etc. in the present state of the art, polycrystalline silicon (polysilicon) and polycrystalline silicon-germanium are known to be thermally-mutable materials. While the making of resistors from polysilicon is the most common application, it is known to make a resonator from polysilicon, in which the resonant frequency of the resonator is trimmable due to changes in its mechanical properties.

### BRIEF DESCRIPTION OF THE DRAWINGS

These and other features, aspects and advantages of the present invention will become better understood with regard to the following description and accompanying drawings wherein:

FIG. 1: Shows a schematic of a micro-platform (top view) suspended over a cavity;

FIG. 2: Shows a cross-sectional view of the micro-platform in FIG. 1;

FIG. 3: Shows examples of layouts intended to dissipate more power at the edges of the heat-targeted region;

FIG. 4: Shows a micro-platform with a single resistor filling a substantial portion of the available area;

FIG. 5: Shows a micro-platform with a single functional resistor, filling a substantial portion of the available area, with a heater resistor around its perimeter;

FIG. 6: Shows a cross-sectional view of a micro-platform with a single functional resistor filling a substantial portion of the available area, with a heater resistor placed above it embedded in the micro-platform;

FIG. 7: Shows a cross-sectional view of a micro-platform with a single functional resistor consisting of two polysilicon layers (electrically connected to each other on the chip or micro-platform), both layers filling a substantial portion of the available (top view) area, and a heater resistor around its perimeter.

FIG. 8: Shows a cross-sectional view of a micro-platform with a single functional resistor consisting of two polysilicon layers, both layers filling a substantial portion of the available (top view) area, and with a resistive heater situated in a layer between them;

FIG. 9: Shows a cross-sectional view of a micro-platform with a single functional resistor, and resistive heater around its perimeter on two layers, one above and one below, along with conductive slabs above and below the functional resistor.

### DETAILED DESCRIPTION OF THE PREFERRED EMBODIMENT

It should be noted that for the purpose of this disclosure, trimming is to be understood as increasing or decreasing the room-temperature resistance value of a resistor. It should also be noted that thermally-isolated is meant to describe an element that is isolated from other elements such that the heat flux (proportional to temperature differential) generated between the element and other elements, is generally low. Electrically-isolated is meant to describe an element that is isolated from other elements such that the resistance between this element and other elements is very high (e.g. hundreds of k-ohms). The term signal is meant to describe any data or control signal, whether it be an electric current, a light pulse, or any equivalent. Furthermore, obtaining a constant or flat temperature distribution, T(x), is equivalent to a relatively flat or substantially constant temperature distribution across a resistor. The entire resistance cannot be at the same temperature since a portion of the resistor must be off the micro-platform (due to the continuous nature of resistors) and electrical contacts must be at a lower temperature. Therefore, obtaining a substantially constant temperature distribution across a resistor is understood to mean across a reasonable maximum possible fraction of the resistor. A pulse is to be understood as a short duration of current flow.

The possibility of reducing the noise by trimming supports the potential advantages of using trimmable polycrystalline materials, such as polysilicon, as resistors in high-performance circuits.

In the design of integrated circuits, it is often important to obtain favorable low noise performance, within certain design and process constraints. Some typical constraints for design of an integrated resistor are:
it is polysilicon, or poly-SiGe;
the polysilicon or SiGe has a given average grain size and doping, constrained by certain criteria in the host fabrication process;
it has a certain thickness, d (fixed by the host fabrication process);
has a certain resistivity, p (exact or approximate);
it is desired to have a certain resistance value, R, which corresponds to a certain number of squares, since R=ρ*(# of squares);
it is desired to have favorable noise performance (low noise);

If, in addition to these constraints it is desired that the resistor be thermally trimmable (typically involving local temperatures on the order of 500° C. and above), this is problematic, since for low noise one should use as large an area as possible. If the physical resistor is placed directly on top of the substrate, separated only by thin insulator layer(s), the power required for heating increases proportionally to the area of the resistor, which is prohibitive/problematic for practical high-volume manufacturing (due to heat distribution and layout problems). On the other hand if the large-area resistor is placed on one or more micro-platforms, there are significant advantages. The overall thermal isolation is much better, and furthermore the power required to heat the structure does not rise proportionally to the area of the resistor. The required power will rise inversely with the thermal isolation, which is dominated by the support arms, which do not need to change dramatically as the resistor area increases.

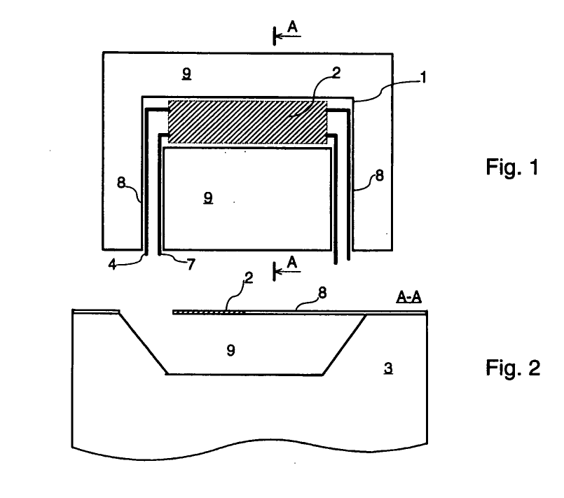

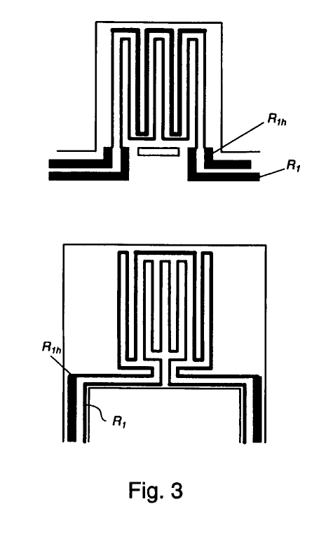

Thus, this invention proposes, as a solution, to place the large-area resistor on a micro-platform having good thermal isolation and low thermal inertia. It can be heated by a separate heater (as shown in FIGS. 1,2), or even by self-heating.

In a preferred embodiment, standard micro-fabrication technology such as CMOS (or BiCMOS, or others), is used to fabricate resistive and dielectric layers to form the cantilever. It is well-known that such dielectric layers as silicon oxide and silicon nitride have low thermal conductivity. Therefore high thermal isolation (approximately 20-50° K./mW) can be achieved for the type of microstructure described here.

Resistors R₁ and R₁ₕ can be made, for example, from polysilicon having sheet resistance of 20-100 Ω/square, which is typical for CMOS technology. Polysilicon resistors can be thermally trimmed by heating them up to temperature higher than a certain threshold Tₜₕ, such as Tₜₕ≅500° C.

A polysilicon resistor having resistance of 10 kΩ (for example) can be readily fabricated in an area of approximately 30 μm×30 μm, if a technological process having 1 μm resolution is used. For a 0.8 μm or 0.35 μm or smaller-feature-sized process, the size of the resistor can be significantly smaller. Therefore all four resistors, two functional with resistance of, for example, 10 kΩ each, and two auxiliary, with preferably lower resistance such as approximately 1 kΩ, can be fabricated on the thermally isolated area 2 with typical area in an approximate range of 500 μm²-20,000 μm², e.g. 50 μm×100 μm. This size is reasonable for many possible applications, and releasing of the whole structure can be done by well-known micro-machining techniques, for example chemical etching in an isotropic etching solution(s), or isotropic dry silicon etch techniques.

Since the resistor is to be heated during trimming, it needs to have a relatively constant spatial temperature distribution T(x) in order to obtain good trimming performance,. Thus, the resistor layout should be designed with this in mind. Some examples of layouts designed to obtain a relatively flat T(x) are shown in FIG. 3.

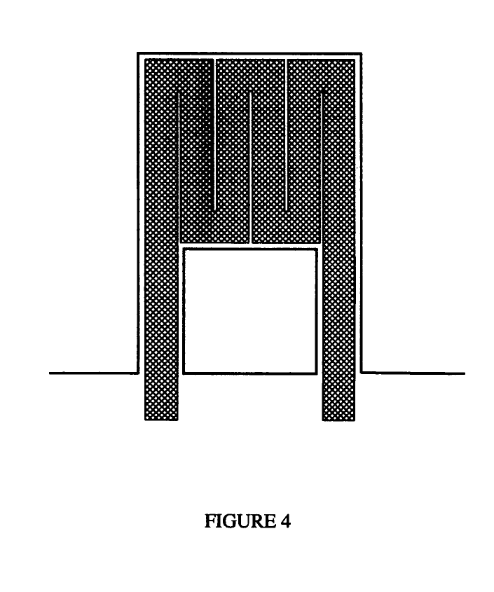

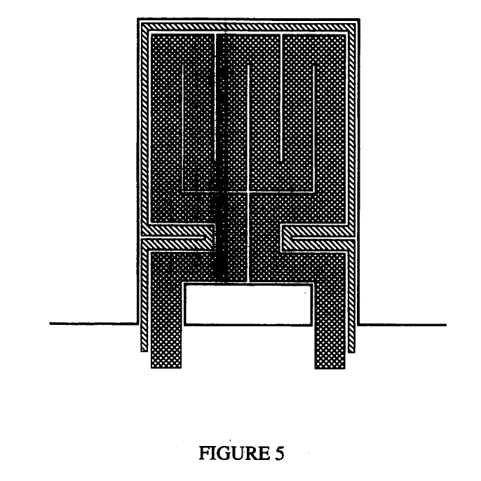

However, the area of a micro-platform cannot be increased indefinitely, due to constraints of mechanical stress in the films composing the micro-platform, and the length of time required to etch the cavity underneath. Thus, it is further preferred to use as much of the micro-platform area as possible to house the resistor. In this invention, at least 70% of the area of the micro-platform is used for the resistor, the rest of it being reserved for heating element or elements, and surrounding insulators. Schematic top views of micro-platforms filling substantial fractions of the available area are shown in FIG. 4 (without separate heater resistor), and FIG. 5 (with separate heater resistor).

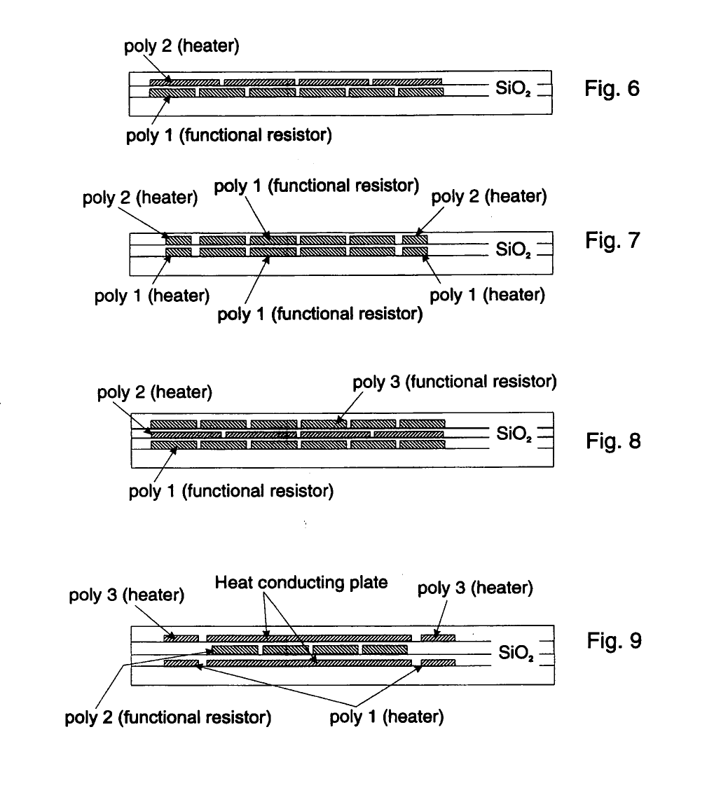

In order to maximize the area for the functional resistor, several additional techniques can be used. FIG. 6 shows the positioning of the heater above the functional resistor, also embedded in the micro-platform, in order to conserve area for the functional resistor. Of course, the heater can be positioned above or below the functional resistor, and the heater layer can have a different thickness, material properties, and line width.

FIG. 7 shows the embodiment of a single functional resistor consisting of two polysilicon layers, both layers filling a substantial portion of the available (top view) area. In this way, the area of the resistor is doubled, for a given micro-platform area. In FIG. 7, the heater is positioned around the perimeter of the functional resistor, while in FIG. 8 the heater is placed in between two polysilicon layers.

The need for flat T(x) is particularly important in the case where the resistor should take a large area. Accordingly, FIG. 9 shows a cross-sectional view of a micro-platform with a single functional resistor, and resistive heater around its perimeter on two layers, one above and one below, along with a conductive slab above and below the functional resistor, all intended to make the temperature distribution more uniform. The material used for the conductive slab could be polysilicon, or any other good heat-conductive material, but it probably should be the same material as the heaters which are on the same layers (preferably all of the conductive layers in the micro-platform should be made out of the same material) for matched thermal expansion, etc, but they do not have to be. Also, the conductive slab can be patterned, and can incorporate an extra auxiliary heater, to serve as an additional heater to help uniformity.

Of course, it is also possible to use several micro-platforms, positioned over one or more cavities, in order to increase the amount of area for the resistor. This has the advantage of not requiring a long cavity etch, and reducing mechanical difficulties associated with large micro-platforms.

In a preferred embodiment, a single thermally-trimmable polysilicon resistor having a total area greater than 10000 μm² is disposed on one or more micro-platforms.

The resistor may be embedded in a micro-platform, whose relative flexibility (compared to embedded in films adherent to a rigid substrate), allows bending to accommodate mechanical stresses. Placing the trimmable electronic circuit element on a micro-platform allows one to apply larger heat treatments with less potential for stress-induced damage. Of course, the micro-platform needs to be properly designed for stress accommodation.

Such low-noise trimmable resistor(s) may be used advantageously in a circuit whose performance is dependent on low-noise performance of said resistor. For example, a low-noise amplifier can benefit from adjustability of offset and gain using such low-noise adjustable resistors. In general, many analog circuits involving amplification depend on high signal-to-noise ratio (SNR), and thus the noise performance of the components comprising the circuit is critical. In a Wheatstone bridge structure with a sensor, the noise of the resistors in the Wheatstone bridge limits the SNR and stability of the entire sensor and sensor-based system. For example, a typical important limiting factor in a bolometer or thermo-anemometer is the thermal noise of an ideal or near-ideal resistor. This invention allows such components to be adjustable without degrading the overall performance of the circuit.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

1. A thermally trimmable circuit, the circuit comprising:
a thermally isolated platform suspended over a depression on a substrate; and
a thermally mutable resistor on said thermally isolated platform taking up a majority of an area of said platform.

2. A circuit as claimed in claim 1, wherein said majority of an area is about 70% of said area.

3. A circuit as claimed in claim 1, wherein said majority of an area is at least 70% of said area.

4. A circuit as claimed in claim 1, wherein a heating element is provided on said platform for heating said resistor.

5. A circuit as claimed in claim 4, wherein said heating element is disposed in a serpentine configuration around said resistor.

6. A circuit as claimed in claim 4, wherein said heating element is disposed around a periphery of said resistor.

7. A circuit as claimed in claim 1, wherein a heating element is provided on a second thermally isolated platform suspended over a depression on said substrate.

8. A circuit as claimed in claim 4, wherein said heating element is placed one of above and below said thermally mutable resistor in order to conserve an area of said platform for said thermally mutable resistor.

9. A circuit as claimed in claim 1, wherein said thermally mutable resistor is distributed over said thermally isolated platform and at least a second thermally isolated platform suspended over a depression on said substrate.

10. A circuit as claimed in claim 1, wherein said thermally mutable resistor is made up of at least two superimposed layers on said platform.

11. A circuit as claimed in claim 10, wherein a heating element is placed on a layer in between said superimposed layers on said platform.

12. A circuit as claimed in claim 1, wherein a conductive slab is placed one of adjacent to, above, and below said resistor to provide a substantially uniform temperature distribution.

13. A circuit as claimed in claim 1, wherein said resistor has a total area of at least 10000 μm².

14. A circuit as claimed in claim 1, wherein said thermally mutable resistor is made of polysilicon.

15. A circuit as claimed in claim 1, wherein said resistor is embedded in a plurality of thermally isolated platforms suspended over at least one depression on said substrate.

16. A circuit as claimed in claim 15, wherein said plurality of platforms are over a common depression.

17. A circuit as claimed in claim 1, wherein said platform contains a plurality of polysilicon layers.

18. A circuit as claimed in claim 1, wherein said resistor is made up of a plurality of layers of polysilicon.

19. A method for providing a circuit including at least one thermally trimmable resistor, the method comprising:
providing a thermally isolated platform suspended over a depression on a substrate; and
placing said trimmable resistor on said thermally isolated platform and maximizing an area of said resistor on said platform such that said component covers a majority of said platform.

20. A method as claimed in claim 19, wherein said maximizing said area of said resistor comprises covering about 70% of said platform.

21. A method as claimed in claim 19, wherein said maximizing said area of said resistor comprises covering at least 70% of said platform.

22. A method as claimed in claim 19, further comprising providing a heating element on said platform for heating said resistor.

23. A method as claimed in claim 22, wherein said providing a heating element comprises disposing said heating element in a serpentine configuration around said resistor.

24. A method as claimed in claim 22, wherein said providing a heating element comprises disposing said heating element around a periphery of said resistor.

25. A method as claimed in claim 19, further comprising providing a second thermally-isolated platform suspended over a depression on said substrate and placing a heating element on said second thermally-isolated platform.

26. A method as claimed in claim 22, wherein said providing a heating element comprises placing said heating element one of above and below said resistor.

27. A method as claimed in claim 19, further comprising providing a second thermally-isolated platform suspended over a depression on said substrate and distributing said resistor over said thermally-isolated platform and said second thermally-isolated platform.

28. A method as claimed in claim 19, wherein said resistor is made up of at least two superimposed layers on said platform.

29. A method as claimed in claim 28, further comprising placing a heating element on a layer in between said superimposed layers on said platform.

30. A method as claimed in claim 19, further comprising placing a conductive slab adjacent to said resistor to provide a substantially uniform temperature distribution.

31. A method as claimed in claim 19, wherein said resistor has a total area of at least 10000 μm².

32. A method as claimed in claim 19, wherein said resistor is made of polysilicon.

33. A method as claimed in claim 19, wherein said resistor is embedded in a plurality of thermally isolated platforms.

34. A method as claimed in claim 33, wherein said plurality of platforms are over a common depression.

35. A method as claimed in claim 19, wherein said platform contains a plurality of polysilicon layers.

36. A method as claimed in claim 19, wherein said resistor is made up of a plurality of layers of polysilicon.

37. A thermally trimmable circuit, the circuit comprising:
a thermally isolated platform suspended over a depression on a substrate; and
a thermally mutable resistor embedded in said thermally-isolated platform and composed of a plurality of superimposed layers, whereby a large effective area of said resistor covers a majority of said platform.

38. A circuit as claimed in claim 37, further comprising a heating element for heating said resistor.

39. A circuit as claimed in claim 38, wherein said heating element is on said platform.

40. A circuit as claimed in claim 39, wherein said heating element is disposed in a serpentine configuration around said resistor.

41. A circuit as claimed in claim 39, wherein said heating element is disposed around a periphery of said resistor.

42. A circuit as claimed in claim 38, wherein said heating element is provided on a second thermally isolated platform suspended over a depression on said substrate.

43. A circuit as claimed in claim 38, wherein said heating element is placed on a layer in between said superimposed layers on said platform.

44. A circuit as claimed in claim 37, wherein a conductive slab is placed one of adjacent to, above, and below said resistor to provide a substantially uniform temperature distribution.

45. A circuit as claimed in claim 37, wherein said resistor has a total area of at least 10000 μm².

46. A circuit as claimed in claim 37, wherein said thermally mutable resistor is made of polysilicon.

47. A circuit as claimed in claim 37, wherein said resistor is embedded in a plurality of thermally isolated platforms suspended over at least one depression on said substrate.

48. A circuit as claimed in claim 47, wherein said plurality of platforms are over a common depression.

49. A circuit as claimed in claim 37, wherein said platform contains a plurality of polysilicon layers.

50. A circuit as claimed in claim 37, wherein said resistor is made up of a plurality of layers of polysilicon.

51. A method for providing a thermally trimmable circuit, the method comprising:
providing a thermally isolated platform suspended over a depression on a substrate;
embedding a thermally mutable resistor composed of a plurality of superimposed layers in said thermally-isolated platform; and
maximizing an area of said resistor embedded in said platform such that said component covers a majority of said platform.

52. A method as claimed in claim 51, further comprising providing a heating element for heating said resistor.

53. A method as claimed in claim 52, wherein said heating element is on said platform.

54. A method as claimed in claim 53, wherein said heating element is disposed in a serpentine configuration around said resistor.

55. A method as claimed in claim 53, wherein said heating element is disposed around a periphery of said resistor.

56. A method as claimed in claim 52, wherein said heating element is provided on a second thermally isolated platform suspended over a depression on said substrate.

57. A method as claimed in claim 52, wherein said heating element is placed on a layer in between said superimposed layers on said platform.

58. A method as claimed in claim 51, wherein a conductive slab is placed one of adjacent to, above, and below said resistor to provide a substantially uniform temperature distribution.

59. A method as claimed in claim 51, wherein said resistor has a total area of at least 10000 μm².

60. A method as claimed in claim 51, wherein said resistor is made of polysilicon.

61. A method as claimed in claim 51, wherein said resistor is embedded in a plurality of thermally isolated platforms suspended over at least one depression on said substrate.

62. A method as claimed in claim 61, wherein said plurality of platforms are over a common depression.

63. A method as claimed in claim 51, wherein said micro-platform contains a plurality of polysilicon layers.

64. A method as claimed in claim 51, wherein said resistor is made up of a plurality of layers of polysilicon.

65. A method for designing a circuit having a plurality of thermally mutable resistors having different power dissipation and noise tolerance requirements, the method comprising:
identifying a desired value for said noise tolerance and said power dissipation for each of said plurality of resistors;
selecting a resistance value for each of said plurality of resistors; and
selecting a dimension for each of said plurality of resistors as a function of said power dissipation and noise tolerance requirements to yield a trimmable range including said resistance value.

66. A method as claimed in claim 65, wherein said selecting a dimension comprises selecting a minimum value for said dimension while respecting said requirements.

67. A method as claimed in claim 65, wherein said selecting a dimension comprises selecting a total grain number for each of said plurality of resistors.

68. A method as claimed in claim 65, wherein said selecting a dimension comprises selecting a grain size for each of said plurality of resistors.

69. A method as claimed in claim 65, wherein at least one of said plurality of resistors is on a thermally isolated platform suspended over a depression on a substrate.

70. A method as claimed in claim 69, wherein said at least one of said plurality of resistors covers a majority of an area of said platform.

71. A method as claimed in claim 70, wherein said at least one of said plurality of resistors covers about 70% of said area of said platform.

72. A method as claimed in claim 70, wherein said at least one of said plurality of resistors covers at least 70% of said area of said platform.

73. A method as claimed in claim 69, further comprising providing a heating element on said platform for heating said at least one of said plurality of resistors.

74. A method as claimed in claim 73, wherein said providing a heating element comprises disposing said heating element in a serpentine configuration around said at least one of said plurality of resistors.

75. A method as claimed in claim 73, wherein said providing a heating element comprises disposing said heating element around a periphery of said at least one of said plurality of resistors.

76. A method as claimed in claim 69, further comprising providing a second thermally-isolated platform suspended over a depression on said substrate and placing a heating element on said second thermally-isolated platform.

77. A method as claimed in claim 73, wherein said providing a heating element comprises placing said heating element one of above and below said at least one of said plurality of resistors.

78. A method as claimed in claim 69, further comprising providing a second thermally-isolated platform suspended over a depression on said substrate and distributing said at least one of said plurality of resistors over said thermally-isolated platform and said second thermally-isolated platform.

79. A method as claimed in claim 69, wherein said at least one of said plurality of resistors is made up of at least two superimposed layers on said platform.

80. A method as claimed in claim 79, further comprising placing a heating element on a layer in between said superimposed layers on said platform.

81. A method as claimed in claim 69, further comprising placing a conductive slab adjacent to said at least one of said plurality of resistors to provide a substantially uniform temperature distribution.

82. A method as claimed in claim 69, wherein said at least one of said plurality of resistors has a total area of at least 10000 μm².

83. A method as claimed in claim 65, wherein said plurality of resistors are made of polysilicon.

84. A method as claimed in claim 69, wherein said at least one of said plurality of resistors is embedded in a plurality of thermally isolated platforms suspended over at least one depression on said substrate.

85. A method as claimed in claim 84, wherein said plurality of platforms are over a common depression.

86. A method as claimed in claim 69, wherein said platform contains a plurality of polysilicon layers.

87. A method as claimed in claim 65, wherein said plurality of resistors are made up of a plurality of layers of polysilicon.

88. A circuit comprising a plurality of thermally mutable resistors having different power dissipation and noise tolerance requirements, characterized in that a dimension for each of said plurality of resistors is set as a function of said power dissipation and noise tolerance requirements to yield a trimmable range including a desired parameter value.

89. A circuit as claimed in claim 88, wherein said dimension corresponds to a minimum value while respecting said requirements.

90. A circuit as claimed in claim 88, wherein at least one of said plurality of resistors is on a thermally isolated platform suspended over a depression on a substrate.

91. A circuit as claimed in claim 90, wherein said at least one of said plurality of resistors covers a majority of an area of said platform.

92. A circuit as claimed in claim 91, wherein said at least one of said plurality of resistors covers about 70% of said area of said platform.

93. A circuit as claimed in claim 91, wherein said at least one of said plurality of resistors covers at least 70% of said area of said platform.

94. A circuit as claimed in claim 88, further comprising a heating element on said platform for heating said at least one of said plurality of resistors.

95. A circuit as claimed in claim 94, wherein said heating element comprises is disposed in a serpentine configuration around said at least one of said plurality of resistors.

96. A circuit as claimed in claim 94, wherein said heating element is disposed around a periphery of said at least one of said plurality of resistors.

97. A circuit as claimed in claim 90, further comprising a second thermally-isolated platform suspended over a depression on said substrate having a heating element thereon.

98. A circuit as claimed in claim 95, wherein said heating element is one of above and below said at least one of said plurality of resistors.

99. A circuit as claimed in claim 90, further comprising a second thermally-isolated platform suspended over a depression on said substrate and wherein said at least one of said plurality of resistors is distributed over said thermally-isolated platform and said second thermally-isolated platform.

100. A circuit as claimed in claim 90, wherein said at least one of said plurality of resistors is made up of at least two superimposed layers on said platform.

101. A circuit as claimed in claim 100, further comprising a heating element on a layer in between said superimposed layers on said platform.

102. A circuit as claimed in claim 90, further comprising a conductive slab one of adjacent to, above, and below said at least one of said plurality of resistors to provide a substantially uniform temperature distribution.

103. A circuit as claimed in claim 90, wherein said at least one of said plurality of resistors has a total area of at least 10000 μm².

104. A circuit as claimed in claim 88, wherein at least one of said plurality of resistors is made of polysilicon.

105. A circuit as claimed in claim 90, wherein said at least one of said plurality of resistors is embedded in a plurality of thermally isolated platforms suspended over at least one depression on said substrate.

106. A circuit as claimed in claim 105, wherein said plurality of platforms are over a common depression.

107. A circuit as claimed in claim 90, wherein said platform contains a plurality of polysilicon layers.

108. A circuit as claimed in claim 88, wherein at least one of said plurality of resistors is made up of a plurality of layers of polysilicon.
